(19) United States
(12) Patent Application Publication
(10) Pub. No.: US 2023/0387878 A1
(43) Pub. Date: Nov. 30, 2023

(54) Modular Electronic Cigarette

(71) Applicant: TELEFONKTIEBOLAGET LM ERICSSON (PUBL), Stockholm (SE)

(72) Inventors: Benjamin Kaiser, Basel (CH); Tobias Kaiser, Basel (CH); Stefan Bauer, Tubingen (DE); Daniel Bock, Chemnitz (DE); Michael Schwitzer, Lichtenau (DE)

(21) Appl. No.: 18/027,591

(22) PCT Filed: Sep. 21, 2020
(86) PCT No.: PCT/EP2020/076326

§ 371 Date: Mar. 21, 2023

(51) Int. Cl. H03H 7/01

(52) U.S. Cl. CPC H03H 7/0138

(57) ABSTRACT

A filter arrangement (1) comprises a filter housing (2) with a housing base (3) and housing walls (4). A cover arrangement (6) closes the filter housing (2). Resonator inner conductors (8) extend from the housing base (3) to the cover arrangement (6) and end at a distance therefrom. Each of the first resonator inner conductors (8) comprises a first and a second end (8a, 8b). The first end (8a) is galvanically connected to the housing base (3). At least one insulator assembly (15) is arranged between the second end (8b) of the respective first resonator inner conductor (8) and the cover arrangement (3). The respective first resonator inner conductor (8) is variable in length and resilient along its longitudinal axis so that the second end (8b) can be moved towards and away from the first end (8a), thereby keeping the insulator assembly (15) pressed against the cover arrangement (6).

### TECHNICAL FIELD

The invention relates to a filter arrangement for mobile communication antennas and to a mobile communication antenna comprising a filter arrangement.

### BACKGROUND

Filter arrangements which are also called RF-filters, have been used for filtering and/or combining RF signals since the very beginning of radio operations. Common types are coaxial metal cavity resonators as well as dielectric resonators and dielectrically loaded resonators.

Both the number of resonators and the unloaded Q of these resonators are determining the electrical losses of the filter. Dielectrics are typically used to reduce electrical losses, due to their high unloaded Q. Otherwise dielectrics can be used while maintaining sufficient unloaded Q, to reduce the filter's volume.

A typical filter can be found in the U.S. Pat. No. 10,084,222 B1 for example. This document shows an RF-filter in cavity structure comprising a resonator inner conductor unit extending from the housing base towards the housing lid. The resonator inner conductor also comprises a dielectric medium between its end and the lid of the housing.

Unfortunately, the filter structure described in U.S. Pat. No. 10,084,222 B1 is quite large and that the electrical parameters are hard to reproduce. This makes it challenging or even impossible to obtain a compact filter arrangement comprising a plurality of signal paths, which would also make a MIMO operation feasible in the low band. Such a MIMO operation would require a plurality of transmitting channels and the plurality of receiving channels for each of the two orthogonal polarizations (±45°, elliptic, circular).

As such, it would be desirable to have a filter arrangement and a mobile communication antenna which could provide 2, 4, 8, 16, 32 or 64 transmitting channels and receiving channels in the low band thereby increasing the bandwidth to the mobile devices. Besides the compact design of the filter arrangement reproducible electrical parameters are strongly needed.

### SUMMARY

An object of the present invention is seen in building a compact filter arrangement that can be used in the mobile communication antenna, wherein the electrical parameters are reproducible so that MIMO operation is also feasible in the low band (600 MHz or 650 MHz or 698 MHz to 960 MHz).

The object is solved by a filter arrangement for a mobile communication antenna according to claim 1 and by the mobile communication antenna comprising the filter arrangement according to claim 16. Claims 2 to 15 describe further embodiments of the filter arrangement.

The filter arrangement for mobile communication antennas according to the present invention comprises a filter housing. The filter housing in turn comprises a housing base and housing walls which enclose at least a first receiving room. Furthermore, a cover arrangement is provided which encloses the filter housing. At least a first connection port and a second connection port are provided to (electrically) connect the filter arrangement to other parts of the mobile communication antenna (like for example the phase shifter arrangement and/or the feeder cables and/or the power amplifier and/or the low noise amplifier). Also, m first resonator inner conductors are provided, with m≥1, 2, 3, 4, 5, 6, 7, 8, 9, 10, 11, 12, 13, 14, 15. The first resonator inner conductors are arranged in the first receiving room and extend from the housing base in the direction of the cover arrangement and end at a distance spaced apart from the cover arrangement. The first resonator inner conductors are preferably electrically conductive and are ideally made of a metal or metal alloy. They could also be made of a dielectric like plastic which is then covered by an electrically conductive layer. The respective m first resonator inner conductor is arranged between the at least one first connecting port and the second connecting port. As such, a first filter path is established. Each of the m first resonator inner conductors comprise a first end and an opposite second end. The first end of each of the m first resonator inner conductors is galvanically connected to the housing base. However, the respective m first resonator inner conductors and the housing base are separate elements and they are not made of a single metal piece. Between the second end of the respective m first resonator inner conductor and the cover arrangement at least one insulator assembly is arranged. The respective m first resonator inner conductor is variable in length and resilient along its longitudinal axis so that the second end can be moved to works and away from the first end. As such, the insulator assembly is always pressed and held against the cover arrangement.

As a result, the insulator assembly (which most likely comprises or consists of ceramics) is always firmly placed while proper electrical contacts are maintained as well. By using the spring force of the respective m first resonator inner conductor a compensation for any mechanical tolerances of the insulator assembly (ceramic) as well as any other part of the further housing is achieved. Furthermore, the respective m first resonator inner conductor according to the present invention can also compensate for any thermal expansion or ageing/settling effects during the lifetime of the filter arrangement.

In a preferred embodiment of the present invention, the respective m first resonator inner conductor comprises a circumferential wall which encloses an inner room. The circumferential wall of the respective m first resonator inner conductor comprises over at least a part of its length at least one fold or plurality of folds. Therefore, the respective m first resonator inner conductor is variable in length and has resilient properties along its longitudinal axis. Instead of the wording “fold” the wording “bellow” could also be used. In other words, the respective m first resonator inner conductor is at least in one part shaped like a bellow (and its longitudinal dimension). The at least one bellow or the plurality of bellows are acting as a spring and are permanently compensating for tolerances in the longitudinal direction (=axial direction).

In another embodiment of the present invention, the circumferential wall of the respective m first resonator inner conductor comprises at least over a part of its length at least one region with the larger outer circumference and a smaller outer circumference so that the at least one fold is formed. Preferably one fold, two folds, three folds, four folds, five folds, six folds or more than six folds are used which are spaced apart from each other in the longitudinal direction. Preferably, longitudinally spaced regions are used with an alternating larger outer circumference and smaller outer circumference. In that case, the inner side of the circumferential wall could be smooth for example. In addition or alternatively, the circumferential wall of the respective m first resonator inner conductor could also comprise over at least a part of its length at least one region with larger inner circumference and a smaller inner circumference. Preferably, longitudinally spaced regions are used within alternating larger inner circumference and smaller inner circumference so that the folds are formed. In that case, the outer side of the circumferential wall could be smooth for example.

In another embodiment of the present invention, the individual folds of the respective m first resonator inner conductor are spaced apart from one another in one plane each. Alternatively, the individual folds are helix-shaped with at least some folds being connected to each other to form a single fold.

In another embodiment of the present invention the first resonator inner conductor is a drilled and/or milled part. The drilling or milling could occur from the outside of the respective m first resonator inner conductor and/or from the inside. As such, the longitudinally spaced regions with larger and smaller outer and/or inner circumference are formed. The respective m first resonator inner conductor could also be an embossed and rolled part. In that case, the folds are embossed into a metal strip which is in turn rolled into a sleeve shape to form the respective m first resonator inner conductor.

In another embodiment of the present invention, the respective first resonator inner conductor comprises at least two sleeve-shaped parts which are telescopically slidable against each other. A first sleeve-shaped part comprises the first end and is galvanically connected to the housing base via this first end. The first sleeve-shaped part is therefore arranged stationary. A second sleeve-shaped part comprises the second end and is galvanically connected to the first sleeve-shaped part. The second sleeve-shaped part is slidable relative to the first sleeve-shaped part. A spring arrangement is connected with its first end to the second sleeve-shaped part and is stationary fixed with its second end. As such, the second sleeve-shaped part is constantly held under mechanical tension. The insulator assembly is arranged between the second end of the second sleeve-shaped part and the cover arrangement.

In another embodiment of the present invention, the respective m first resonator inner conductor is soldered with its first end to the housing base or attached to the housing base via a snap-in connection. Alternatively or additionally, the respective m first resonator inner conductor is soldered with its second end to the insulator assembly or the insulator assembly is soldered to the cover arrangement.

In another embodiment of the present invention, the respective m first resonator inner conductor comprises the circumferential wall which encloses an inner room. The respective m first resonator inner conductor comprises a first flange which is formed at the first end and which is directed (projects) into the inner room. As such, the respective m first resonator inner conductor rests with its first flange on the housing base. Alternatively or additionally, the respective m first resonator inner conductor comprises a second flange. The second flange is formed at the second end and is directed (projects) into the inner room or away from the inner room (outwardly). The second flange of the respective m first resonator inner conductor serves as the support surface for the insulator assembly.

In another embodiment of the present invention, a screw is provided which is arranged in the inner room of the respective m first resonator's inner conductor. The screw comprises a screw head and a screw body. This screw head rests on the first flange. This screw body protrudes from the first end of the respective m first resonator inner conductor and engages into a screw opening in the housing base. As such, the respective m first resonator inner conductor is screwed to the housing base. This ensures that the respective m first resonator inner conductor stays in place and is galvanically connected to the base of the housing.

In another embodiment of the present invention, the housing base comprises at least one pedestal arrangement. The respective m first resonator inner conductor is arranged on that pedestal arrangement. The pedestal arrangement and the housing base are preferably made of a single piece. In addition or alternatively the housing base could also comprise at least one indentation. In this case, the respective m first resonator inner conductor is arranged in the at least one indentation. This allows that higher respective m first resonator inner conductors might be used to establish a certain filter characteristic.

In another embodiment of the present invention, the insulator assembly comprises at least one locking protrusion which engages in a locking recess of the cover arrangement. In addition or alternatively, the insulator assembly could also comprise a locking recess, wherein a locking protrusion in the cover arrangement engages in the locking recess of the insulator assembly. This ensures that the insulator assembly stays in place and avoids lateral movement. Alternatively or in addition, the insulator assembly could also comprise the at least one locking projection which in turn engages in a locking recess at the second end of the respective m first resonator inner conductor. It would also be possible, that the insulator assembly comprises the at least one locking recess so that a locking protrusion at the second end of the respective m first resonator inner conductor engages with that locking recess.

In another embodiment of the present invention, the insulator assembly comprises a through-hole which is located (at least) in the region of its center in which the insulator assembly is arranged without electrical contact (contact-free) to the respective first resonator inner conductor. As such, expensive (ceramic) material which is used for manufacturing the insulator assembly can be saved.

In another embodiment of the present invention, the insulator assembly lies without any gap at (gap-free) the second end of the respective first resonator inner conductor. Alternatively or in addition, the insulator assembly lies/rests against the cover arrangement without any gaps. This is especially achieved, because the respective m first resonator inner conductor presses the insulator assembly against the cover arrangement with the force that is preferably greater than 1N, 2N, 3N, 4N, 5N, 6N, 7N, 8N, 9N or greater than 10N and/or which is preferably less than 15N, 12N, 10N, 8N, 6N, 4N or less than 2N.

In another embodiment of the present invention, the housing base and the housing walls enclose at least a second receiving room. Furthermore, n second resonator inner conductors are provided with n≥1, 2, 3, 4, 5, 6, 7, 8, 9, 10, 11, 12, 13, 14, 15. The respective n second resonator inner conductor extends in the second receiving room from the housing base in the direction towards the cover arrangement and ends at a distance spaced apart from the cover arrangement. The respective n second resonator inner conductor has preferably the same structure as the respective m first resonator inner conductor. As such, the respective n second resonator inner conductor comprises a first end and an opposite second end. The first end of the respective n second resonator inner conductor is galvanically connected to the housing base. At least one insulator assembly is arranged between the second end of the respective n second inner conductor and the cover arrangement. The respective n second resonator inner conductor is variable in length and resiliently formed along its longitudinal axis so that the second end is movable towards and away from the first end. As such, the insulator assembly is pressed and held constantly against the cover arrangement. Furthermore, at least the third connection port is provided. The at least one third connection port is coupled to the first connection port (in that case, the filter arrangement operates as a combiner) or to a fourth connection port. The coupling is achieved via a second filter path. The respective n second resonator inner conductors are arranged within that second filter path.

In another embodiment of the present invention, the respective n second resonator inner conductors are arranged on the same side of the housing base as the respective m first resonator inner conductor. In addition or alternatively, the respective n second resonator inner conductors are arranged on the opposite side of the housing base where the respective m first resonator inner conductors are arranged. In that case, the filter arrangement comprises a stacked structure.

The mobile communication antenna according to the present invention comprises a filter arrangement as previously described. Furthermore, the mobile communication antenna comprises at least one dual-polarized MIMO radiator arrangement with X transmitting channels and Y receiving channels for each of the two polarizations. The values for X and Y are preferably 2, 4, 16, 32 or 64. The dual-polarized MIMO radiator arrangement comprises a plurality of radiators which are preferably arranged on a first side of a reflector arrangement. Furthermore, a phase shift arrangement and the filter arrangement are arranged on a second side of the reflector arrangement. The phase shifter arrangement can comprise one of more phase shifters (differential phase shifter, linear phase shifter). However, the phase shifter arrangement can also be arranged in a radio (as software) so that the phase is adjusted and/or set electronically.

Within another embodiment, the filter arrangement comprises X filter paths for the transmitting channels for each polarization comprising the respective (first/second/ . . . /X) resonator inner conductors. The filter arrangement also comprises Y filter paths for the receiving channels for each polarization comprising the respective (first/second/ . . . /Y) resonator inner conductors. By using the filter arrangement of the present invention, it is possible to establish a compact filter so that the plurality of necessary signal paths can be incorporated so that the mobile communication antenna also supports MIMO operation in the low band.

The filter arrangement could also be named as low-band filter arrangement.

The filter arrangement can preferably be operated in a frequency range of 600 MHz or 650 MHz or 698 MHz to 960 MHz.

### BRIEF DESCRIPTION OF THE DRAWINGS

Different embodiments of the invention will be described in the following, by way of example and with reference to the drawings. The same elements are provided with the same reference signs. The figures show in detail:

FIG. 1: a mobile communication antenna with a filter arrangement according to the present invention;

FIG. 2A: a top view of the filter arrangement without a cover arrangement according to the present invention;

FIG. 2B: a top view of the filter arrangement with the cover arrangement according to the present invention;

FIG. 2C: a view of one front side of the filter arrangement according to the present invention;

FIG. 3: a longitudinal section through the filter arrangement according to the present invention;

FIGS. 4A, 4B: a first embodiment of a resonator inner conductor with an insulator assembly;

FIG. 5: a second embodiment of a resonator inner conductor with an insulator assembly;

FIG. 6: a top view of the filter arrangement without a cover arrangement but with two coupled filter paths according to the present invention;

FIG. 7: a top view of the filter arrangement without a cover arrangement but with two separated filter paths according to the present invention; and

FIG. 8: a longitudinal section through the filter arrangement having two separated filter paths on different sides of the housing base according to the present invention.

### DETAILED DESCRIPTION

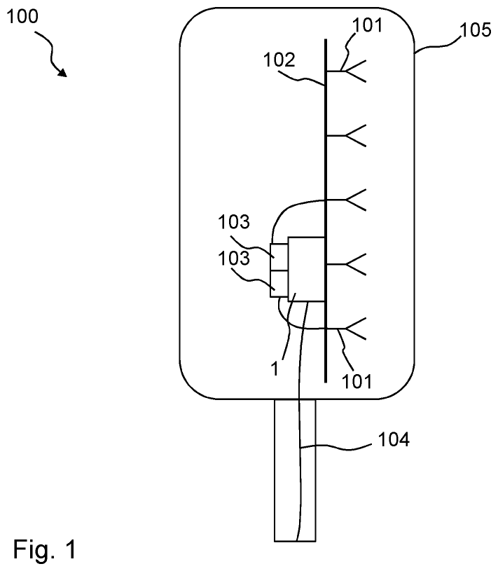

FIG. 1 shows a mobile communication antenna 100 with at least one dual-polarized MIMO radiator arrangement 101. There is also a reflector arrangement 102 on which the at least one dual-polarized MIMO radiator arrangement 101 is arranged. The at least one dual-polarized MIMO radiator arrangement 101 is arranged on a first side of the reflector arrangement 102. It is configured to be operated in a frequency range preferably starting from 600 MHz or 650 MHz or 698 MHz ranging up to 960 MHz. Those frequencies are part of the low band.

Additional radiators, especially for higher frequencies could also be arranged on the first side of the reflector arrangement 102. For example, radiators that can be used in the mid band or in the high band can also be arranged on the first side of the reflector arrangement 102. Radiators configured to be operable in the mid band are able to transmit and receive communication signals which are preferably arranged between 1695 MHz to 2700 MHz. Radiators configured to be operable in the high band are able to transmit and receive communication signals which are preferably arranged between 3300 MHz to 3800 MHz.

Preferably, a plurality of dual-polarized MIMO radiator arrangements 101 are used. They are spaced apart from each other in longitudinal direction of the mobile communication antenna 100 and preferably also in the lateral (horizontal) direction.

The dual-polarized MIMO radiator arrangement 101 is preferably configured to transmit and/or receive mobile communication signals in two orthogonal polarizations. The orthogonal polarizations could be for example ±45°, circular or elliptic.

On the second side of the reflector arrangement 102, a phase shifter arrangement 103 for each of the two polarizations for the dual-polarized MIMO radiator arrangement 101 could be arranged. In addition, a matching network could also be provided. Furthermore, a power amplifier configured to amplify signals which are intended to be transmitted through the mobile communication antenna 100 to various mobile devices could also be arranged on the second side of the reflector arrangement 102. Alternatively or in addition, a low noise amplifier could also be arranged on the second side of the reflector arrangement 102. Using the low noise amplifier (LNA) signals which are received through the mobile communication antenna 100 from various mobile devices could be amplified before being sent to the base station (not shown) via the feeder cables 104. Furthermore, a filter arrangement 1, which could be in the form of a combiner for example, is arranged on the second side of the reflector arrangement 102. A common port of the filter arrangement 1 could be connected to the central port of the respective phase shifter arrangement 103. The TX-port and the RX-port could then be connected to the respective power amplifier or low noise amplifier. A radome 105 closes the mobile communication antenna 100. Obviously, the phase shifter arrangement 103 could also be implemented as software in a radio.

The filter arrangement 1 and the respective phase shifter arrangement 103 for each of polarizations of the dual-polarized MIMO radiator arrangements 101 could be integrated in the same housing. The housing base of the filter arrangement 1 would divide the receiving rooms for the filter arrangement 1 and the phase shift arrangement 103, wherein an opening between the housing base is used to connect the common port of the filter arrangement 1 to the respective phase shifter arrangement 103. The housing is preferably made of metal or ideally die-cast aluminium. Covers on both sides of the housing then enclose the respective receiving rooms.

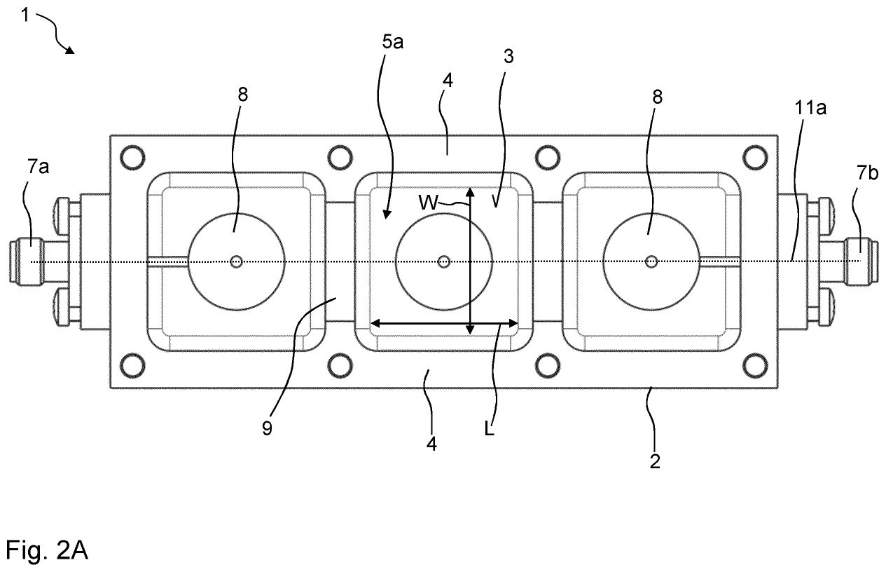

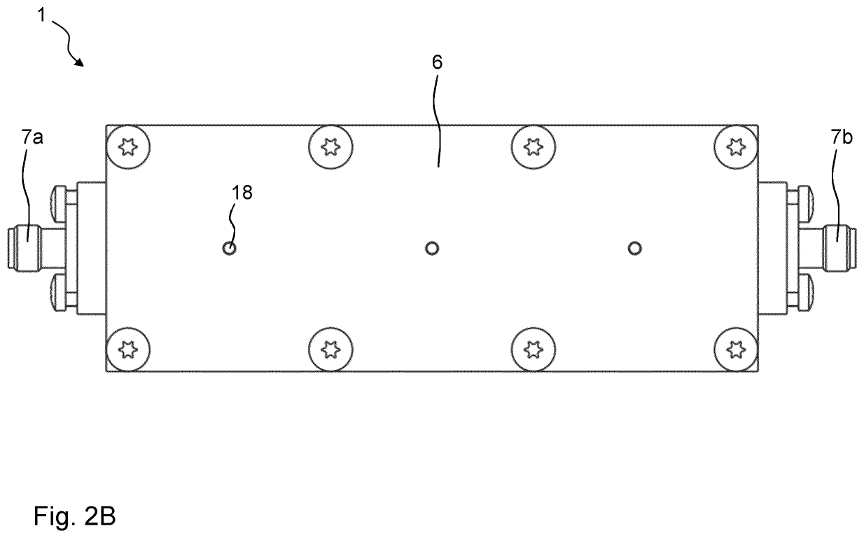

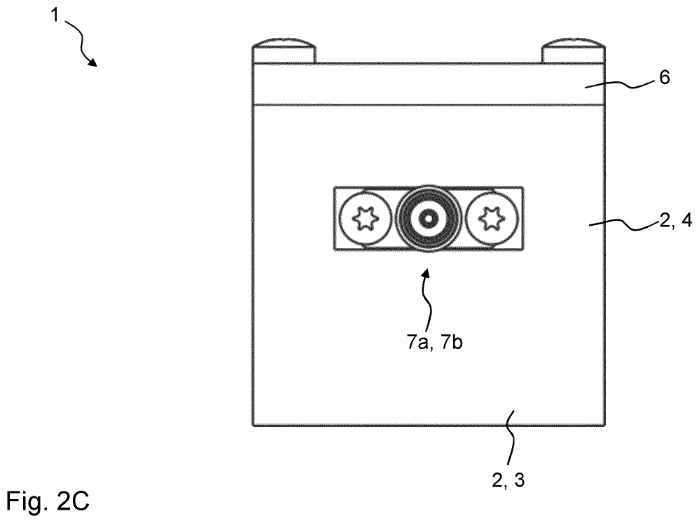

FIG. 2A shows a top view of the filter arrangement 1. The filter arrangement 1 comprises a filter housing 2. The filter housing 2 comprises a housing base 3 and housing walls 4. The filter housing 2 encloses at least a first receiving room 5a. In FIG. 2A the filter housing 2 is depicted without the cover arrangement 6. Such a cover arrangement 6 is shown in FIG. 2b, where the filter housing 2 is closed. Furthermore at least a first connection port 7a and the second connection port are shown. There are also m first resonator inner conductors 8, with m≥1, 2, 3, 4, 5, 6, 7, 8, 9, 10, 11, 12, 13, 14, 15. The first resonator inner conductors 8 are arranged in the first receiving room 5a. They extend from the housing base 3 in the direction of the cover arrangement 6 and end at a distance from the cover arrangement 6. In FIG. 2A there are shown three first resonator inner conductors 8. The respective m first resonator inner conductors 8 are preferably arranged in such a way that a capacitive coupling between at least two neighboring first resonator inner conductors 8 as possible. As such, there is preferably a line of sight between two neighboring first resonator inner conductors 8. The first of the respective m first resonator inner conductors 8 is preferably galvanically coupled to the first connection port 7a. A capacitive coupling could also be possible. The last (m-th) of the respective m first resonator inner conductors 8 is preferably galvanically coupled to the second connection port 7b. A capacitive coupling could also be possible.

The coupling between two neighboring first resonator inner conductors 8 can be adjusted by a separating element 9. The separating element 9 extends preferably from the housing base 3 in the direction of the cover arrangement 6 and ends at a distance from the cover arrangement 6. As such, the capacitive coupling between two neighboring first resonator inner conductors 8 is limited. The separating element 9 is basically an integral part of the housing base 3. The respective separating element 9 between each neighboring first resonator inner conductors 8 could be of a different height. They could also be all of the same height. As can also be seen, the separating element 9 together with the housing walls 4 not only define a common first receiving room 5a but also separate resonator chambers. Each resonator chamber comprises only one first resonator inner conductor 8. The volume of each resonator chamber could be the same or could also be different. Preferably, the volume can be adjusted by using tuning screws for example. The length L of each resonator chamber is preferably 1.5 cm. The width W of each resonator chamber is preferably 1.5 cm. The height H of each resonator chamber is preferably 1.5 cm. However, one, some or all of these values can deviate independently of each other by preferably less than ±50%, ±40%, ±30%, ±20%, ±15%, ±10% or less than ±5%.

The first and the second connecting port 7a, 7b are coupled with each other by a first filter path 11a. The first filter path 11a is indicated by using a dotted line.

FIG. 2C shows the view of one front side of the filter arrangement 1. The cover arrangement 6 closes the filter housing 2. The first or second connecting port 7a, 7b are also shown.

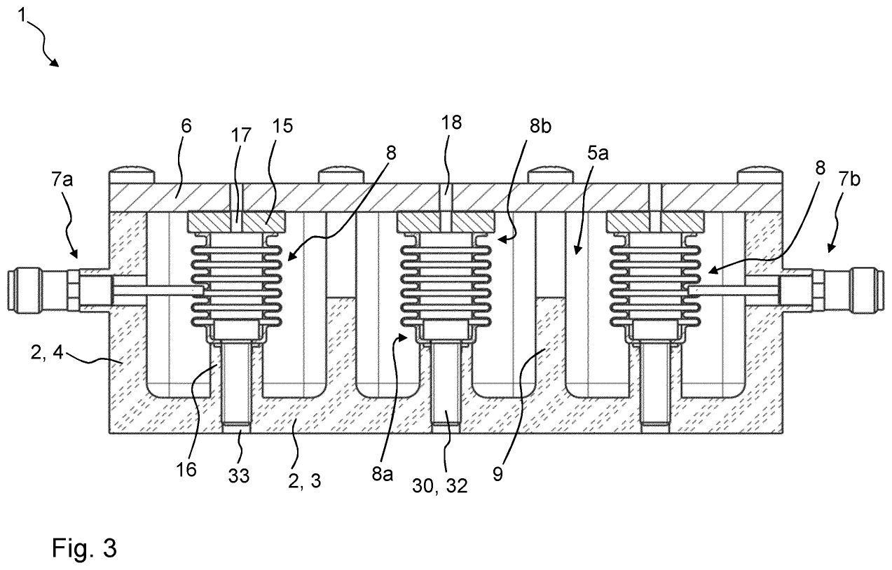

FIG. 3 shows a longitudinal section through the filter arrangement 1. Each of the first resonator inner conductors 8 comprise a first end 8a and an opposite second end 8b. The first end 8a of the respective m first resonator inner conductor 8 is galvanically connected to the housing base 3. This can be done by using a solder joint for example. It could also be done by connecting the respective m first resonator inner conductor 8 via a snap-in connection to the resonator base 3. Furthermore, a screwed connection can also be used, so that the respective m first resonator inner conductor 8 is pressed at the resonator base 3.

At least one insulator assembly 15 is arranged between the second end 8b of the respective m first resonator inner conductor 8 and the cover arrangement 6. The insulator assembly 15 could be made of a single piece or a plurality of pieces. The insulator assembly 15 is preferably a ceramic and ideally a ceramic disc or ceramic sleeve. The εᵣ is preferably larger than 1.0 or 1.2 or 1.4 or 1.6 or 1.8 or 2.0 or 2.2 or larger than 2.4. The ceramic probably has a high density of up to or even more than 2 kg/dm³. As such, the thickness of the insulator assembly 15 is preferably less than 8 mm, 7 mm, 6 mm, 5 mm, 4 mm, 3 mm or less than 2 mm, but preferably larger than 1 mm, 3 mm, 5 mm or larger than 7 mm.

The diameter of the insulator assembly 15 (if circular) is preferably less than 10 mm, 7 mm, 6 mm, 5 mm, 4 mm or less than 3 mm, but preferably larger than 2 mm, 5 mm, 7 mm or larger than 8 mm.

The respective m first resonator inner conductor 8 is variable in length and resilient along its longitudinal axis. In that case, the second end 8b can be moved towards and away from the first end 8a. As a result, the insulator assembly 15 is constantly pressed against the cover arrangement 6.

The force that is applied for pressing the insulator assembly 15 against the cover arrangement 6 is preferably greater than 1N, 2N, 3N, 4N, 5N, 6N, 7N, 8N, 9N or greater than 10N and/or is preferably less than 15N, 12N, 10N, 8N, 6N, 4N or less than 2N. More preferably, the insulator assembly 15 is in direct contact to the cover arrangement 6. As such, there is preferably no gap between the insulator assembly 15 and the cover arrangement 6.

Furthermore, there is also no gap between the second end 8b of the respective m first resonator inner conductor 8 and the insulator assembly 15. Optionally, the insulator assembly 15 could be soldered to the second end 8b of the respective m first resonator inner conductor 8 and/or to the cover arrangement 6. As can also be seen, the housing base 3 comprises at least one pedestal arrangement 16. The respective m first resonator inner conductor 8 is arranged on the at least one pedestal arrangement 16 with its first end 8a. This could be true for all of the respective m first resonator inner conductors 8. Contrary to that or in addition at least one or some of the respective m first resonator inner conductors 8 could also be arranged within an indentation of the housing base 3.

Preferably, the insulator assembly 15 comprises a through-hole 17 which is located at least in the region in its center. The insulator assembly 15 is preferably not in contact in that region (its center) with the second end 8b of the respective m first resonator inner conductor 8. This reduces the needed material for manufacturing the insulator assembly 15 and thereby reduces the overall weight. The cover arrangement 6 preferably also comprises an opening 18 which is right above (coincident) the through-hole 17 of the insulator assembly 15. This opening 18 could be used for inserting a tuning screw. The tuning screw could then protrude through the opening 18 and the through-hole 17.

If the insulator assembly 15 is not soldered to the cover arrangement 6 and the second end 8b of the respective m first resonator inner conductor 8, locking protrusions as well as corresponding locking recesses can be used to ensure that the insulator assembly 15 remains stationary. The locking protrusion and/or recess can be applied to the insulator assembly 15 and to the respective parts of the cover arrangement 6 and/or the second end 8b of the respective m first resonator inner conductor 8.

The cover arrangement 6 could be made of a single piece. However, the wording “cover arrangement” also includes the possibility that a plurality of covers all lids are used in order to enclose the filter housing 2. As such, a first part of the cover arrangement 6 could enclose a first side of the filter housing 2 and the second part of the cover arrangement 6 could enclose a second side of the filter housing 2.

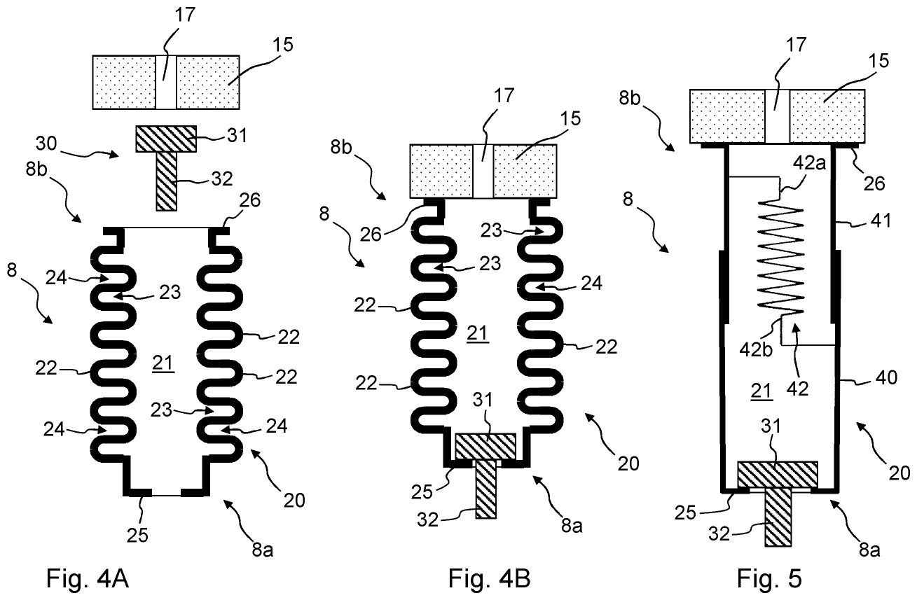

FIGS. 4A, 4B show a first embodiment of the respective m first resonator inner conductor 8. The respective m first resonator inner conductor 8 comprises a circumferential wall 20 which encloses an inner room 21. The circumferential wall 20 comprises of at least a part of its length a plurality of folds 22. These folds 22 allow that the respective m first resonator inner conductor 8 is variable in length and has resilient property along its longitudinal axis.

Preferably the respective m first resonator inner conductor 8 only has folds 22 over 80%, 70%, 60% or less than 50% of its length in the longitudinal axis.

The folds are preferably created by using a massive cylinder of a metal or metal alloy, like brass or copper. Then by using a milling or drilling process are continuous opening is achieved and as such a part of the inner room 21 is created. Now it is possible that either the inner side or the outer side of the circumferential wall 20 is smooth and therefore free of any folds 22. However, this does not necessarily have to be the case. It could also be possible (like shown in FIGS. 4A, 4B) that neither the inner side nor the outer side is smooth. In that case, another drilling or milling process is used to create inner recesses 23 in the inner side of the circumferential wall. Another drilling or milling process could also be used to create outer recesses 24 in the outer side of the circumferential wall. The inner recesses 23 are accessible from the inner room 21. The outer recesses 24 are only accessible from outside the circumferential wall 20.

In other words, the circumferential wall of the respective m first resonator inner conductor 8 comprises over the at least part of its length longitudinally spaced regions with the larger outer circumference and the smaller outer circumference (they form the recesses 24). As such, the at least one fold 22 is formed. In FIGS. 4A, 4B there are a plurality of folds 22 which means that regions with larger outer circumferences and a smaller outer circumferences alternate. Within FIGS. 4A, 4B this is also the case for the inner circumference. As can be seen, the circumferential wall 20 comprises over at least a part of its length longitudinally spaced regions with a larger inner circumference (they form the recesses 23) and a smaller inner circumference. As such the individual folds 22 are formed.

The respective m first resonator inner conductor 8 could comprise one fold 22 or a plurality of folds 22. The folds 22 could all be the same or one or more of the folds 22 could be different from other ones.

In FIGS. 4A, 4B, it is also shown, that the individual folds are arranged in parallel to each other. Preferably wherein each fold 22 is arranged in its own plane, wherein the planes of the various folds 22 are spaced apart in the longitudinal axis of the respective m first resonator inner conductor 8. The planes are preferably arranged parallel to the cover arrangement 6.

It could also be possible, that the individual folds 22 are helix-shaped. Preferably at least some folds 22 are connected to each other to form a single fold 22 which also runs in the longitudinal direction.

Furthermore, the respective m first resonator inner conductor 8 comprises a first flange 25 and a second flange 26. The first flange 25 is formed is arranged at the first end 8a of the respective m first resonator inner conductor 8. The first flange 25 extends into the inner room 21 so that the respective m first resonator inner conductor 8 rests with this first flange 25 on the housing base 3. The first flange 25 is preferably not elastic. The first flange 25 is a part that has not been milled or drilled away. Furthermore, the respective m first resonator inner conductor 8 comprises a second flange 26. The second flange 26 is arranged at the second end 8b and extends either into the inner room 21 or outwardly (as shown in FIGS. 4A, 4B). The second flange 26 serves as a support surface for the insulator assembly 15.

The first and/or second flange 25, 26 are preferably parallel to the cover arrangement 6.

The insulator assembly 15 preferably protrudes beyond the second end 8b of the respective m first resonator inner conductor 8 on some or all sides. This is preferably also true even if there is a second flange 26 arranged at the second end 8b of the respective m first resonator inner conductor 8.

Furthermore, as screw 30 is provided and inserted through the second end 8b of the respective m first resonator inner conductor 8. The screw 30 comprises a screw head 31 and the screw body 32. The screw head 31 rests on the first flange 25. The screw body 32 protrudes from the first end 8a of the respective m first resonator inner conductor 8 and engages into the screw opening 33 (FIG. 3 for example) in the housing base 3. The screw opening 33 comprises a thread so that the respective m first resonator inner conductor 8 is screwed to the housing base 3.

It would also be possible that the respective m first resonator inner conductor 8 is not milled and/or drilled out of the solid metal piece (like in FIGS. 4A, 4B) but that the respective m first resonator inner conductor 8 is an embossed and rolled part. In that case, a metal strip, preferably made of brass or copper could be used. The individual folds 22 would then be embossed into the metal strip. After that, the metal strip could be rolled into a cylindrical form so that it forms the respective m first resonator inner conductor 8. In order to avoid that the metal strip opens up again, a latching connection could be used to make sure that it keeps its cylindrical form. In addition or alternatively, parts of the metal strip could be soldered to each other or welded to ensure that the metal strip keeps its form. The first and/or second flange 25, 26 could incorporated by a bending process.

FIG. 5 shows another embodiment of the respective m first resonator inner conductor 8. The respective m first resonator inner conductor 8 comprises a first sleeve-shaped part 40 and a second sleeve-shaped part 41 which are telescopically slidable against each other. The first sleeve-shaped part 40 comprises the first end 8a and the second sleeve-shaped part 41 comprises the second end 8b. A spring arrangement 42 is connected with its first end 42a to the second sleeve-shaped part 41. The spring arrangement 42 is stationary fixed with its second end 42b. The second end 42b can for example be attached to the first sleeve-shaped part 40 or to the filter housing 2. As a result, the second sleeve-shaped part 40 one is held under a constant pretension, so that the second end 8b of the second sleeve-shaped part 41 is pushed away from the first sleeve-shaped part 40. The insulator assembly 15 is arranged between the second end 8b of the second sleeve-shaped part 41 and the cover arrangement 6.

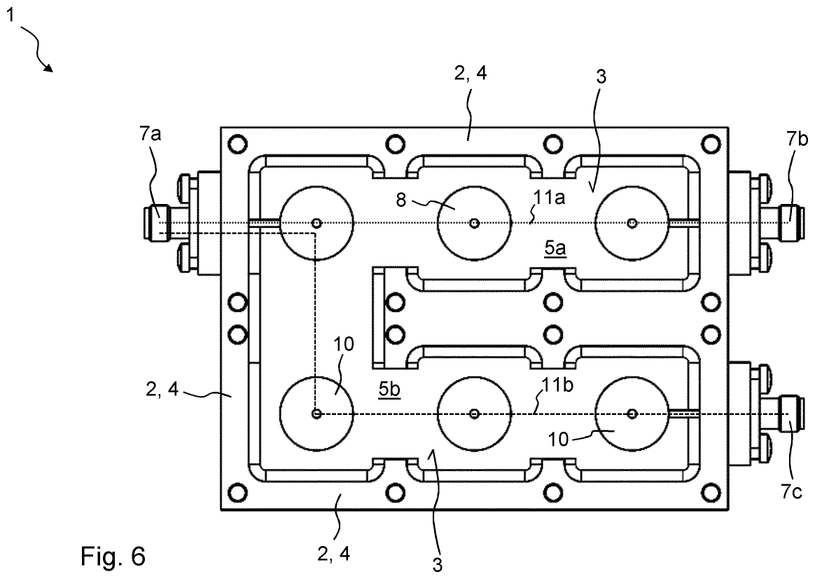

FIG. 6 shows a top view of the filter arrangement 1 without a cover arrangement 6 but with two coupled filter paths 11a, 11b. The housing base 3 and the housing walls 4 also enclose at least n second receiving room 5b. There are also in second resonator inner conductors 10 provided, with n≥1, 2, 3, 4, 5, 6, 7, 8, 9, 10, 11, 12, 13, 14, 15. The structure of the respective n second resonator inner conductor 10 preferably equals the structure of the respective m first resonator inner conductor 8. The respective n resonator inner conductor 10 extends in the second receiving room 5b from the housing base 3 in the direction of the cover arrangement 6 and ends at the distance spaced apart from the cover arrangement 6. The respective n second resonator inner conductor 10 also comprises a first end 10a and a second end 10b. The first end 10a is galvanically connected to the housing base 3. An insulator assembly 15 is arranged between the second end 10b and the cover arrangement 6. The respective n second resonator inner conductor 10 is also variable in length and resiliently formed along its longitudinal axis so that the second end 10b is movable towards and away from the first end 10a. As such, the insulator assembly 15 is constantly pressed against the cover arrangement 6.

FIG. 6 also shows at least one third connection port 7c. A second filter path 11b is formed between the third connection port 7c and the first connection port 7a. The respective n second resonator inner conductors 10 are arranged within that second filter path. The second filter path 11b preferably also uses at least one of the respective m first resonator inner conductors 8. The second filter path 11b is indicated by a dashed line. As such, the first and the second receiving rooms 5a, 5b are connected to each other.

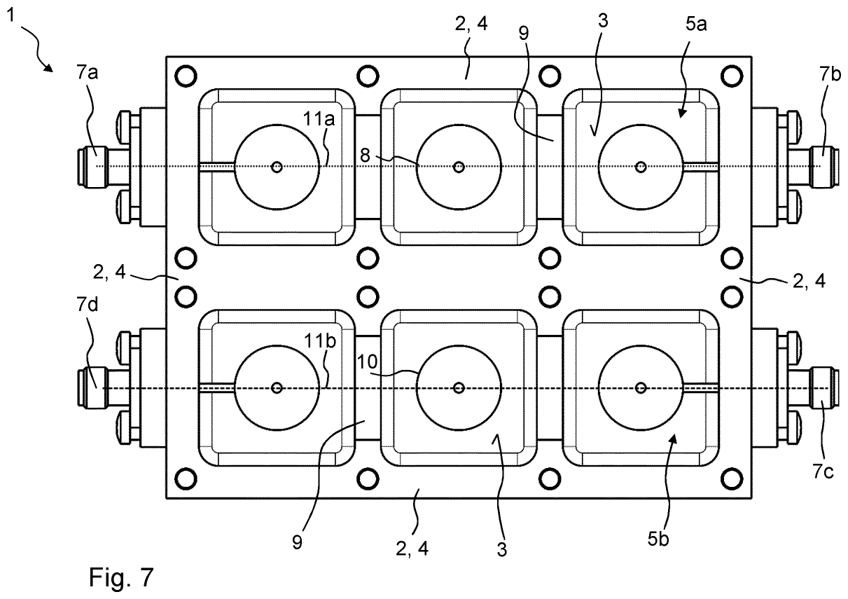

Contrary to FIG. 6, FIG. 7 shows a top view of the further arrangement 1 without the cover arrangement 6 and two filter paths 11a, 11b running independently from each other. The first and the second receiving rooms 5a, 5b are preferably not connected to each other. In addition, a fourth connection port 7d is provided. The respective n second resonator inner conductors 10 are arranged between the at least one third connection port 7c and the fourth connection port 7d.

FIGS. 6 and 7 show that the respective n second resonator inner conductors 10 and the respective m first resonator inner conductors 8 are arranged on the same side of the housing base 3.

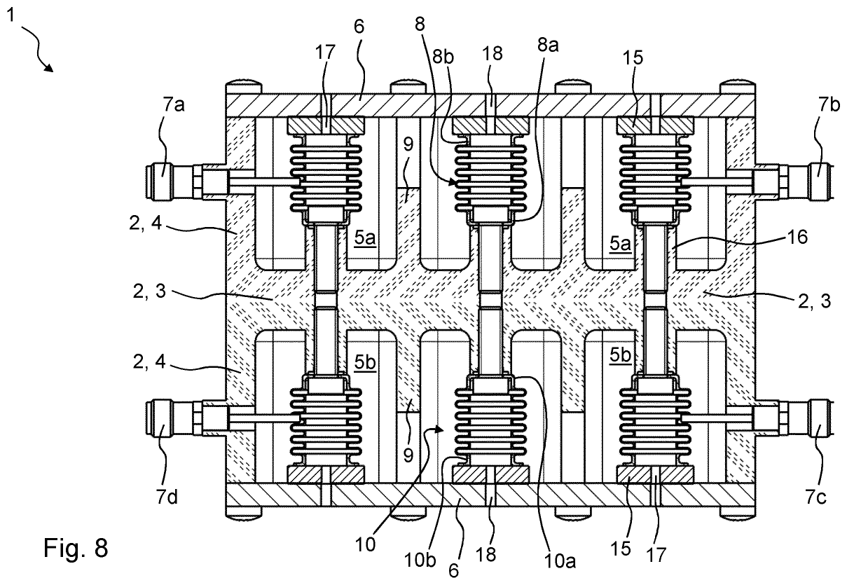

FIG. 8 in turn shows that the respective n second resonator inner conductors 10 and the respective m first resonator inner conductors 8 are arranged on opposite sides of the housing base 3. In that case, the filter arrangement 1 comprises a stacked structure.

It could also be possible, that couplings (inductive or capacitive) between two none adjacent respective m first resonator inner conductors 8 are provided. The same could also be true for two none adjacent respective n second resonator inner conductors 10. It could also be possible, that a cross coupling between a respective m first resonator inner conductor 8 and a respective n second resonator inner conductor 10 occurs.

Additionally, there could also be resonator inner conductors arranged within the respective receiving room 5a, 5b which are not resilient. Those “normal” resonator inner conductors would then not be part of the set of the respective first and second resonator inner conductors 8, 10.

The filter arrangement 1 preferably comprises a respective filter path for all of the transmitting channels and for all of the receiving channels for the first and for the second polarization. Within each of the plurality of filter paths at least one or a plurality of respective resonator inner conductors 8, 10 are arranged.

In the following some advantages of the filter arrangement 1 are emphasized separately.

The filter arrangement 1 is preferably in the form of a cavity structure.

The filter arrangement 1 preferably comprises the following features:
the first connection port 7a is galvanically, magnetically or capacitively connected to the first of the m first resonator inner conductors 8; and/or the second connection port 7b is galvanically, magnetically or capacitively connected to the m-th first resonator inner conductor 8;
and/or
the third connection port 7c is galvanically, magnetically or capacitively connected to the first of the n second resonator inner conductors 10; and/or the fourth connection port 7d is galvanically, magnetically or capacitively connected to the n-th second resonator inner conductor 10.

The filter arrangement 1 preferably comprises the following feature:
the pedestal arrangement 9 is constructed in one piece with the housing base 3.

The filter arrangement 1 preferably comprises the following features:
the respective first and/or second resonator inner conductor 8, 10 is constructed in one piece.

The filter arrangement 1 preferably comprises the following feature:
the resilient property of the respective first and/or second resonator inner conductor 8, 10 is only achieved by the construction of the circumferential wall.

The filter arrangement 1 preferably comprises the following feature:
the respective first and/or second resonator inner conductor 8, 10 comprises or consists of metal or a metal alloy, in particular brass.

The filter arrangement 1 preferably comprises the following feature:
the individual folds 22 are each arranged in one plane, wherein the individual planes are arranged parallel to each other and parallel to the cover arrangement 6.

The filter arrangement 1 preferably comprises the following feature:
the free end of the wound-up metal strip which extends along its longitudinal axis is soldered and/or welded and/or latched to the remaining part of the metal strip for at least part of its length.

The filter arrangement 1 preferably comprises the following feature:
the at least one tuning element is inserted through an opening 18 in the cover arrangement 6 and extends through the through-hole 17 in the insulator assembly 15.

The filter arrangement 1 preferably comprises the following feature:
the folds 22 are formed by a multiple alternating diameter along the longitudinal axis of the respective first and/or second resonator inner conductor 8, 10.

The filter arrangement 1 preferably comprises the following feature:
the respective first and/or second resonator inner conductor 8, 10 is sleeve-shaped.

The mobile communication antenna 100 with the filter arrangement 1 preferably comprises the following features:
the filter arrangement 1 comprises X filter paths for the transmitting channels for each polarization with the respective resonator inner conductors 8, 10;
the filter arrangement 1 comprises Y filter paths for the receiving channels for one polarization each with the respective resonator inner conductors 8, 10.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1. A filter arrangement (1) for mobile communication antennas (100) having the following features:
a filter housing (2) is provided, which comprises a housing base (3) and housing walls (4), which enclose at least a first receiving room (5a);
a cover arrangement (6) is provided which closes the filter housing (2);
at least a first and a second connection port (7a, 7b) are provided;
m first resonator inner conductors (8) are provided, with m≥1, 2, 3, 4, 5, 6, 7, 8, 9, 10, 11, 12, 13, 14, 15, wherein the respective m first resonator inner conductor (8) is arranged in the first receiving room (5a) and extends from the housing base (3) in the direction of the cover arrangement (6) and end at a distance from the cover arrangement (6);
in between the at least one first and second connecting ports (7a, 7b) the respective first resonator inner conductor (8) is arranged, thereby forming a first filter path (11a);
each of the first resonator inner conductors (8) comprises a first end (8a) and an opposite second end (8b);
the first end (8a) of each of the first resonator inner conductors (8) is galvanically connected to the housing base (3);
at least one insulator assembly (15) is arranged between the second end (8b) of the respective first resonator inner conductor (8) and the cover arrangement (3);
the respective first resonator inner conductor (8) is variable in length and resilient along its longitudinal axis so that the second end (8b) can be moved towards and away from the first end (8a), thereby keeping the insulator assembly (15) pressed against the cover arrangement (6).

2. Filter arrangement (1) according to claim 1, characterized by the following features:
the respective first resonator inner conductor (8) comprises a circumferential wall (20) which encloses an inner room (21);
the circumferential wall (20) of the respective first resonator inner conductor (8) comprises over at least a part of its length at least one fold (22) or plurality of folds (22), so that the respective first resonator inner conductor (8) is variable in length and has resilient properties along its longitudinal axis.

3. Filter arrangement (1) according to claim 2, characterized by the following features:
the circumferential wall (20) of the respective first resonator inner conductor (8) comprises over the at least a part of its length:
a) at least one region with a larger outer circumference and a smaller outer circumference so that the fold (22) is formed; or
b) longitudinally spaced regions with a larger outer circumference and a smaller outer circumference, so that the folds (22) are formed; and/or
the circumferential wall (20) of the respective first resonator inner conductor (8) comprises, over at least a part of its length:
a) at least one region with a larger inner circumference and a smaller inner circumference so that the fold (22) is formed; or
b) longitudinally spaced regions with a larger inner circumference and a smaller inner circumference so that the folds (22) are formed.

4. Filter arrangement (1) according to claim 2 or 3, characterized by the following features:
the individual folds (22) of the respective first resonator inner conductor (8) are spaced apart from one another in one plane each; or
the individual folds (22) are helix-shaped, with at least some folds (22) being connected to each other to form a single fold (22).

5. Filter arrangement (1) according to one of the claims 2 to 4, characterized by the following features:
the first resonator inner conductor (8) is a drilled and/or milled part; or
the first resonator inner conductor (8) is an embossed and rolled part, wherein the folds (22) are embossed into a metal strip and wherein this metal strip is rolled to form the first resonator inner conductor (8).

6. Filter arrangement (1) according to claim 1, characterized by the following features:
the respective first resonator inner conductor (8) comprises at least two sleeve-shaped parts (40, 41) which are telescopically slidable against each other;
a first sleeve-shaped part (40) comprises the first end (8a) and is galvanically connected to the housing base (3) via the first end (8a) and is arranged stationary;
a second sleeve-shaped part (41) comprises the second end (8b) and is galvanically connected to the first sleeve-shaped part (40) and is slidable relative to the first sleeve-shaped part (40);
a spring arrangement (42) is connected with its first end (42a) to the second sleeve-shaped part (41) and is stationary fixed with its second end (42b), so that the second sleeve-shaped part (41) is held under a pretension;
the insulator assembly (15) is arranged between the second end (8b) of the second sleeve-shaped part (41) and the cover arrangement (6).

7. Filter arrangement (1) according to any one of the previous claims, characterized by the following features:
the respective first resonator inner conductor (8) is soldered with its first end (8a) to the housing base (3) or attached to the housing base (3) via a snap-in connection; and/or
the respective first resonator inner conductor (8) is soldered with its second end (8b) to the insulator assembly (15); or
the insulator assembly (15) is soldered to the cover arrangement (6).

8. Filter arrangement (1) according to any one of the previous claims, characterized by the following features:
the respective first resonator inner conductor (8) comprises a circumferential wall (20) which encloses an inner room (21);
the respective first resonator inner conductor (8) comprises a first flange (25) which is formed at the first end (8a) and protrudes inwardly, wherein the respective first resonator inner conductor (8) rests with this first flange (25) on the housing base (3); and/or
the respective first resonator inner conductor (8) comprises a second flange (26), which is formed at the second end (8b) and protrudes inwardly or outwardly, wherein the second flange (26) of the respective first resonator inner conductor (8) serves as a support surface for the insulator assembly (15).

9. Filter arrangement according to claim 8, characterized by the following features:
a screw (30) is provided, which is arranged in the inner room (21) of the respective resonator inner conductor (8) and comprises a screw head (31) and a screw body (32);
the screw head (31) rests on the first flange (25);
the screw body (32) protrudes from the first end (8a) of the respective first resonator inner conductor (8) and engages in a screw opening (33) in the housing base (3), so that the respective first resonator inner conductor (8) is screwed to the housing base (3).

10. Filter arrangement (1) according to any one of the previous claims, characterized by the following features:
the housing base (3) comprises at least one pedestal arrangement (9), wherein at least one first resonator inner conductor (8) is arranged on the at least one pedestal arrangement (9); and/or
the housing base (3) comprises at least one indentation, wherein the at least one first resonator inner conductor (8) is arranged in the at least one indentation.

11. Filter arrangement (1) according to any one of the previous claims, characterized by the following features:
the insulator assembly (15) comprises at least one locking protrusion, wherein the at least one locking protrusion engages in a locking recess of the cover arrangement (6); and/or
the insulator assembly (15) comprises at least one locking recess, wherein a locking protrusion of the cover arrangement (6) engages in the at least one locking recess; and/or
the insulator assembly (15) comprises at least one locking projection, wherein the at least one locking projection engages in a locking recess at the second end (8b) of the respective first resonator inner conductor (8); and/or
the insulator assembly (15) comprises at least one locking recess, wherein a locking protrusion of the respective first resonator inner conductor (8) engages in the at least one locking recess.

12. Filter arrangement (1) according to any of the previous claims, characterized by the following feature:
the insulator assembly (15) comprises a through-hole (17) at least in the region in its center in which the insulator assembly (15) is arranged contact-free at the respective first resonator inner conductor (8).

13. Filter arrangement (1) according to any of the previous claims, characterized by the following features:
the insulator assembly (15) lies gap-free at the second end (8b) of the respective first resonator inner conductor (8) and/or
the insulator assembly (15) lies against the cover arrangement (6) without any gaps; and/or
the respective first resonator inner conductor (8) presses the insulator assembly (15) against the cover arrangement (6) with a force, whereby the force:
a) is greater than 1N, 2N, 3N, 4N, 5N, 6N, 7N, 8N, 9N or greater than 10N; and/or
b) is less than 15N, 12N, 10N, 8N, 6N, 4N or less than 2N.

14. Filter arrangement (1) according to any of the previous claims, characterized by the following features:
the housing base (3) and the housing walls (4) enclose at least a second receiving room (5b);
n second resonator inner conductors (10) are provided, with n≥1, 2, 3, 4, 5, 6, 7, 8, 9, 10, 11, 12, 13, 14, 15, wherein the respective m second resonator inner conductor (10) extends in the second receiving room (5b) from the housing base (3) in the direction of the cover arrangement (6) and ends at a distance from the cover arrangement (6);
the respective second resonator inner conductor (10) comprises a first end (10a) and an opposite second end (10b);
the first end (10a) of the respective second resonator inner conductor (10) is galvanically connected to the housing base (3);
At least one insulator assembly (15) is arranged between the second end (10b) of each second resonator inner conductor (10) and the cover arrangement (6);
the respective second resonator inner conductor (10) is variable in length and resiliently formed along its longitudinal axis so that the second end (10b) is movable towards and away from the first end (10a), thereby keeping the insulator assembly (15) pressed against the cover arrangement (6);
at least a third connection port (7c) is provided;
the at least one third connection port (7c) is coupled to:
a) the first connection port (7a); or
b) a fourth connection port (7d);
via a second filter path (11b), wherein the respective second resonator inner conductor (10) is arranged in the second filter path (11b).

15. Filter arrangement (1) according to claim 14, characterized by the following features:
the n second resonator inner conductors (10) are arranged on the same side of the housing base (3) as the m first resonator inner conductors (8); or
the n second resonator inner conductors (10) and the m first resonator inner conductors are arranged on the opposite sides of the housing base (3).

16. Mobile communication antenna (100) with a filter arrangement (1) according to any one of the previous claims, characterized by the following features:
at least one dual-polarized MIMO radiator arrangement (101) with X transmitting channels and Y receiving channels is provided for one polarization each, where X=2, 4, 16, 32 or 64 and where Y=2, 4, 16, 32 or 64;
the dual-polarized MIMO radiator arrangement (101) comprises a plurality of radiators arranged on a first side of a reflector arrangement;
a phase shifter arrangement and the filter arrangement (1) are arranged on a second side of the reflector arrangement.
